(19) United States
(12) Patent Application Publication
(10) Pub. No.: US 2006/0047781 A1
(43) Pub. Date: Mar. 2, 2006

(54) Method and system for providing remote portal service modules

(76) Inventors: Ed Anuff, San Francisco, CA (US); Miles Chaston, San Francisco, CA (US); Peter Leiser, Berkeley, CA (US); Jean Tessier, Foster City, CA (US); John Taylor, San Francisco, CA (US)

Correspondence Address: SPRINKLE IP LAW GROUP, 1301 W. 25TH STREET, SUITE 408, AUSTIN, TX, 78705, US

(21) Appl. No.: 11/226,936

(22) Filed: Sep. 15, 2005

Related U.S. Application Data
(63) Continuation of application No. 09/717,299, filed on Nov. 22, 2000.

(51) Int. Cl. G06F 15/16

(52) U.S. Cl. 709/219

(57) ABSTRACT

The present invention is a method for providing Remote Portal Services (RPS). RPS is a system for easily and quickly incorporating remote applications (RPS Services) into a portal. RPS Services may be enabled making the RPS Service available for incorporation onto a server implementing a portal. Enabled RPS Services may be disabled discontinuing the availability of the RPS Service for incorporation onto a server implementing a portal. RPS Services may be incorporated onto and removed from a server implementing a portal server. RPS Services may be added to and removed from a portal implemented on a server. RPS Services are exposed in the portal as modules, without installing, on the server implementing the portal, any software specific to a RPS Service. Enabled RPS Services may be listed on a directory that may be searched and browsed. The present invention may protect the exposure of data stored on servers during communication between servers.

### CROSS-REFERENCE TO RELATED APPLICATION

This application is related to application having Ser. No. 09/573,226, filed on May 19, 2000, now co-pending.

### FIELD OF THE INVENTION

The present invention relates generally to the subject of remote applications. More particularly, the present invention pertains to providing remote services on a portal.

### BACKGROUND OF THE INVENTION

Traditionally, syndication of services, such as personalized content and applications, onto portals has been achieved only through the construction of custom-built modules. These custom-built modules provide for the display and administration of services hosted on a remote system. While custom built modules have solved the problem of syndicating services, their implementation for syndicating personalized content and applications negatively impacts the overall development and improvement of portal framework technology.

A drawback of implementing custom-built modules to syndicate personalized content and applications is delivering upgrades of portal framework technology to customers. Upgrading portal framework technology includes installing new modules on all customer portals that implement the old version of the module. Installing new modules onto customer portals can be very challenging. A primary challenge of installing new modules onto customer portals is that the syndicator must know the users of an old version of a module as well as the version of the module. Knowledge of the version of a module in use by a user is necessary because a new version of a module may only operate on a newer version of the basic portal framework software. Consequently, to ensure the satisfactory and complete delivery of portal framework technology, delivery must be performed a user at a time.

An additional drawback to implementing custom-built modules to syndicate personalized content and applications is that completing an upgrade can take months. The time it takes to complete an upgrade is generally attributed to the significant number of technical tasks that need to be performed. There are, however, occasions when an upgrade of service to all customers may be necessary in an inflexible and short period of time. Such occasions include 1) the syndicator reselling the content or application of a root syndicator; 2) the contract with the root syndicator may change, with immediate consequences on how the portal displays or manages the application; 3) the root syndicator may discontinue their service, requiring that another root syndicator be found to continue the service; or 4) the root syndicator may change their application such that connectors no longer work. Moreover, a contract often exists between the syndicator and customers that guarantees the continued existence of services. Consequently, due to the number technical tasks, failure to transparently upgrade can occur, and thus lead to legal and financial repercussions.

Another drawback of implementing custom-built modules to syndicate personalized content and applications is the cost of upgrading portal framework technology. Upgrading portal framework technology includes research, development and delivery of new services or features. Research, development and delivery of new services or features requires the expenditure of significant resources. Consequently, upgrade, replacement and/or removal of services or features can often be costly.

An additional drawback of implementing custom-built modules to syndicate personalized content and applications is the frequency at which upgrades occur. As mentioned above, the cost to upgrade portal framework technology is significant and the delivery of upgrades time consuming. Accordingly, upgrades are often performed only when significant advancements are made. Appropriately, “nice to have” functionality is provided only when an upgrade occurs. Consequently, time to market for upgrades in portal framework technology are lengthy.

A further drawback of implementing custom built modules to syndicate personalized content and applications is the inability to easily search and browse for services of both root and third party syndicators. There is no central resource that discloses available services for incorporation. Accordingly, services offered cannot be easily promoted by developers nor identified or obtained by customers. Consequently, the marketing of third parties services to customers is limited.

An additional drawback of implementing custom built modules to provide syndication of personalized content and applications is the limited number functions provided for integrating and customization. Examples of the functions that cannot be performed by a customer include 1) integrating existing complex web applications into their portal, while retaining the existing interfaces of the application; 2) developing applications for their portal in languages other than Java; and 3) developing applications for their portal where the majority of the computational effort is done on a remote system, rather than on the portal system itself. Customers generally want the ability to perform one or more of the above functions to improve the scalability and customization of their portal site. Consequently, the customer's ability to customize their portal site is limited.

Accordingly, there is a need for portal framework technology to allow the simultaneous upgrade, replacement and/or removal of a syndicated service or feature. There is a further need for portal framework technology to include a limited number of technical challenges that syndicators must overcome. There is a need for portal framework technology to enable customers to easily integrate their existing applications. There is an additional need for portal framework technology to shorten service time to market. There is a need for portal framework technology to allow inexpensive upgrade, replacement and/or removal of services or features. There is a need for portal framework technology to enabling point and click deployment of services into the portal. There is a need for the portal framework technology to provide a technological solution for third parties to market services to customers. Lastly, there is a need to develop the portal framework technology on top of open standards, such as SOAP and XML.

### SUMMARY OF THE INVENTION

Based on the above and foregoing, it can be appreciated that there presently exists a need in the art for portal framework technology which overcomes the above-described deficiencies.

To achieve the above and other features and advantages, the present invention provides a remote portal services framework or system. This system or framework will be referred to as the Remote Portal Services (hereinafter “RPS”). A RPS system easily and quickly incorporates personalized content and applications into a portal hosted by the RPS system. Any personalized content and application implemented based on the RPS system will be referred to herein as a RPS Service. A RPS Service may be enabled to make the RPS Service available for addition to a portal. An enabled RPS Service may also be disabled to terminate the availability of the RPS Service for addition to a portal. A RPS Service may be enabled and disabled through existing portal interface designed for portal administration. A RPS Service is exposed to a users of the RPS system as a module, without installing any software specific to the RPS Service on a device implementing a portal.

In another aspect of the present invention, a RPS Service may be listed, located and selected. A RPS Services Directory may be used to list any RPS Service available for incorporation throughout a network. A RPS Services Directory may enable a RPS Service to be reviewed and selected for incorporation to device. A RPS Service may be represented on the list by a reference identifier, such as a Uniform Resource Identifier (“URI”). Selection of a reference identifier initiates a communication between the server implementing the portal and the server hosting the selected RPS Service.

In another aspect of the present invention, a RPS system may secure server information. RPS may provide security where a response from a RPS Service to a server that has incorporated the RPS Service includes information about the server hosting the RPS Service. The security can prevent, for example, information from being stolen by eavesdropping on the communication or by pretending to be the hosting server.

In a further aspect of the present invention, a RPS system may protect data stored on, or originating on a server implementing a portal from exposure to other servers. A RPS system does not require that a server implementing a portal expose. “private data,” to the server hosting a RPS Service. Private data includes anything that is associated with a user and identifies the user uniquely, such as user profile information. A RPS system inspects a RPS Service before it is deployed to make sure it does not request any data considered private. Moreover, the inspection occurs even when a manual process initiated by the customer generates the data.

In another aspect of the present invention, a RPS Service located outside a firewall of an intranet and installed on a portal within the intranet may be accessed. The access may be provided with or without a proxy server.

In another aspect of the present invention, a RPS Service provides current status messages. A RPS Service may specify to servers implementing a RPS Service to display to customers a message in cases where the RPS Service cannot be reached or is temporarily unavailable. RPS Services may specify a timeout for each view within a service.

The features and advantages of the present invention that offer these capabilities are described in detail hereinafter with reference to the accompanying figures, which illustrate exemplary embodiments thereof.

### BRIEF DESCRIPTION OF THE DRAWINGS

The details of the present invention, both as to its structure and operation can best be understood by referring to the following description with reference to the accompanying drawings in which:

FIG. 1 is a general block diagram of a system in which the present invention can be implemented;

FIG. 2 is a block diagram illustration of Portal server 102 depicted in FIG. 1;

FIG. 3 is a block diagram illustration of Remote Portal server 106 depicted in FIG. 1;

FIG. 4 is a block diagram illustration of Communication devices 114 depicted in FIG. 1;

FIG. 5 is a flow diagram which depicts the functions performed by the method of incorporating and providing RPS Modules to a Portal server 102 according to the present invention;

FIG. 6 is a flow diagram which depicts the functions performed by the method of eliminating RPS Modules from a Portal server 102 according to the present invention;

FIG. 7 is a flow diagram which depicts the functions performed by the method of adding RPS Modules into a portal according to the present invention;

FIG. 8 is a flow diagram which depicts the functions performed by the method of removing RPS Modules from a portal according to the present invention;

FIG. 9 is a flow diagram which depicts the functions performed by the method of enabling RPS Modules; and

FIG. 10 is a flow diagram which depicts the functions performed by the method of disabling deployed RPS Modules.

### DETAILED DESCRIPTION OF THE INVENTION

To facilitate an understanding of the present invention, it is described more fully hereinafter with reference to specific implementations of the accompanying drawings that show the preferred embodiments of the invention. This invention, however, may be embodied in many different forms and should not be construed as limited to the embodiments set forth herein. Appropriately, these embodiments are provided so that this disclosure will be thorough and complete, and will fully convey the scope of the invention. As will be appreciated by one having skill in the art, the present invention may be embodied as a method, data processing system and computer program product.

The software programs that underlie the invention can be coded in different languages executable with different platforms. In the description that follows, examples of the invention are described in the context of web sites or service that employ Java Server Pages (JSP) or Active Server Pages (ASP). It will be appreciated, however, that the principles that underlie the invention can be implemented with other types of computer software object technologies as well. Furthermore, the present invention can be embodied as a computer program product stored on a computer-readable storage medium. Any suitable computer-readable medium may be utilized including hard disks, CD-ROMs, floppy disks, optical storage devices, magnetic storage devices, etc.

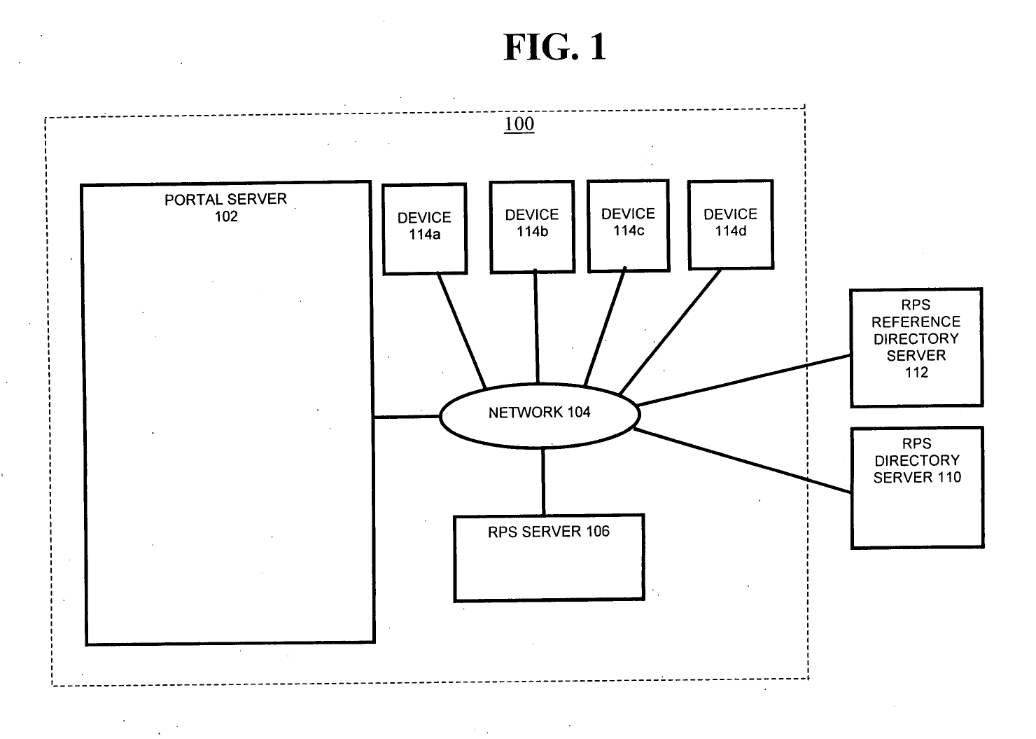

A general depiction of a system in which the present invention can be implemented is illustrated in FIG. 1. In a preferred embodiment of the present invention, system 100 depicted in FIG. 1 includes communication devices 114, Portal server 102, Remote Portal Service server 106 and network 104. In another embodiment of the present invention, a RPS system 100 includes communication devices 114, Portal server 102, Remote Portal Service server 106, network 104 and Remote Portal Service Directory server 110. In another embodiment of the present invention, a RPS system 100 includes communication devices 114, Portal server 102, Remote Portal Service server 106, network 104 and Remote Portal Service Reference Directory server 112.

The RPS system 100 may transmit, using network 104, any combination of voice, video and/or data between devices. In the preferred embodiment of the invention, network 104 transmits data between computers 114, 102 and 106. In another embodiment of the invention, network 104 transmits data between communication devices 114, Portal server 102, Remote Portal Service server 106 and Remote Portal Service Directory server 110. In another embodiment of the present invention, network 104 transmits data between communication devices 114, Portal server 102, Remote Portal Service server 106 and Remote Portal Service Reference Directory server 112.

The RPS system 100 can provide a RPS Service. The method of providing a RPS Service includes enabling, disabling, incorporating, eliminating, adding and removing a RPS Service. Communication devices 114 may be any apparatus from which, and to which, any combination of voice, video and/or data can be transmitted over a network, such as network 104. Communication devices 114 can include computers 114a, web access devices 114b, workstations 114c, telecommunications devices 114d, and the like. Communications devices 114 may perform the function of accessing Portal server 102 and viewing informational content as provided by a RPS Service exposed in a portal to a user as a module. Communications devices 114 may be used by end-users of Portal server 102, such as customers.

Portal server 102 can be any computer that stores application programs and data shared by users of network 104 and that uses libraries, such as Java libraries. In the preferred embodiment of the present invention, Portal server 102 supports Java Server Pages (JSP). In another embodiment of the present invention, Portal server 102 supports Active Server Pages (ASP). Portal server 102 may perform the functions of incorporating, eliminating, adding and removing a RPS Service. An individual or a number of individuals, who are responsible for managing Portal sever 102, may incorporate, eliminate, add and remove a RPS Service. The RPS server 106 may be any computer that stores application programs and data shared by users of network 104. The RPS server 106 may perform the functions of enabling and disabling a RPS Service. An individual or individuals responsible for managing RPS Services may use RPS server 106. The RPS Directory server 110 may perform the functions of locating and listing of RPS Services. The RPS Directory server 110 may be any computer that stores application programs and data shared by users of network 104. The data may include a listing of RPS services available throughout network 104. The RPS Reference Directory server 112 may perform the functions of locating and listing available RPS Services as well as indicating invalid information.

Communication devices 114, RPS server 106 and Portal server 102 may connect to one another by means of a suitable communications network 104. Communication network 104 may be a local area network, a wide area network, the Internet, a wireless network, or the like. The network 104 may transfer information between Portal server 102, RPS server 106 and communications devices 114. The information transferred may include any combination of voice, video and/or data. Network 104 can be implemented as a wireless network or a wired network.

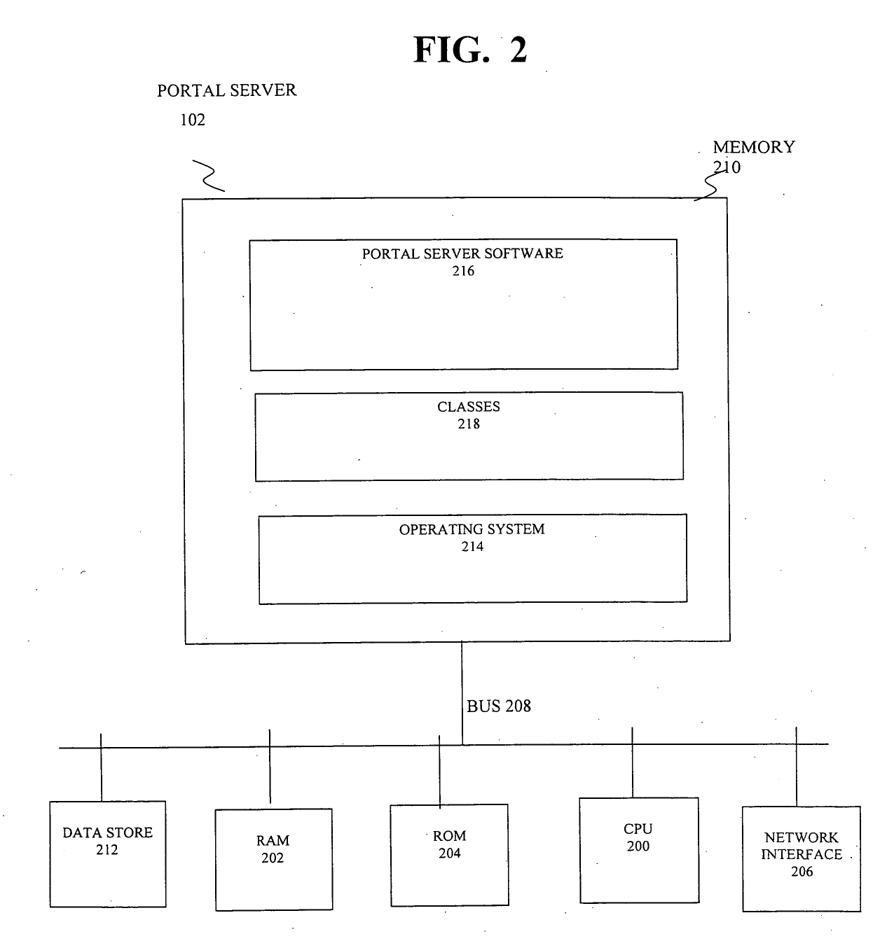

FIG. 2 is a block diagram illustration of Portal server 102. The Portal server 102 may include a central processing unit (CPU) 200, connected by a bus 208, to RAM 202, ROM 204, system memory 210, data store 212 and network interface 206. Network interface 206 is connected to network 104 for communication with RPS server 106 and communication devices 114. Portal server 102 may perform the functions of incorporating, eliminating, adding and removing a RPS Service. The Portal server 102 may connect to other network resources, for example to acquire information from the Internet or an intranet.

In the exemplary embodiment shown in FIG. 2, the various components of the Portal server 102 communicate through a system bus 208 or similar architecture. Accordingly, systems memory 210 is disposed in communication with CPU 200 and data storage 212 through bus 208. Typically, CPU 200 is a microprocessor, such as an INTEL PENTIUM® or AMD® processor, but may also be any processor that executes computer program instructions. Systems memory 210 is the workspace from which all program execution and data processing takes place for Portal server 102. Systems memory 210 includes Portal Server Software 216 and Operating System 214.

Operating System 214 provides overall system functionality. Operating System 214 is the program that, after being initially loaded into the computer, manages all the other programs in Portal server 102. Operating System 214 finds data and delivers it to Portal Server Software 216. Conversely, when Portal Server Software 216 is ready to output, the Operating System 214 transfers the data from Portal Server Software 216 to the appropriate destination. Operating System 214 is responsible for the central management of all devices. Operating System 214 calls on one or more drivers for input and output, and the drivers communicate with the corresponding hardware devices.

Portal Server Software 216 performs the functions that are implemented by Portal server 102 using a library of object-oriented classes 218. The classes may be those in the Java programming language developed by Sun Microsystems, also stored in systems memory 210. The classes 218 enable access to various databases, web servers, scripting environments and mail services. The classes 218 can provide connection to other servers. The classes 218 use other resources as needed, including a data store which provides object persistence via a suitable database interface. In the preferred embodiment of the invention, this connection may be provided by a JDBC interface over a SQL database. In another embodiment based upon an LDAP environment, user management can be provided via JNDI over LDAP.

In a preferred embodiment, Portal Server Software 216 is implemented using object-oriented technology, and thus uses objects as building blocks. Objects are software components designed to work together at runtime without any prior linking or precompilation as a group. The objects represent actors within an overall system. A software component is a module that contains the data as well as the data structure and functions that manipulate the data.

Portal Server Software 216 may provide for the dynamic construction and maintenance of an initial set of views, or set of front pages (hereinafter “portals”), that includes a plurality of modules. Modules are objects that encapsulate a specific bound portion of content at a network address for administration as a unit. Modules follow a singleton design pattern such that only one instance of a module is maintained for the lifetime of a server session. Each module represents a resource that can be accessed by the user through the portal. Some of the modules can be implemented on Portal server 102, whereas other modules may be implemented on a remote host, such RPS server 106. Interaction with a module by end-users using communication devices 114 accesses the information or services provided by the module.

Portal Server Software 216 may implement a RPS Browser Module, a RPS Proxy, and RPS Service Implementation. A RPS Browser Module serves as an interface for performing administration. The RPS Browser Module may be provided as a graphical user interface having objects selectable by an administrator. A RPS Browser Module may instantiate a RPS Proxy. A RPS Proxy encapsulates and supports the use of a RPS Service implementation. A RPS Service Implementation can execute the behavior necessary to satisfy the RPS Protocol. The RPS Protocol is the communications protocol used between RPS Server Software and Portal Server Software 216 to exchange information. Any number of protocols can be used that allows for the exchange of information over network 104 using network interface 206. Network interface 206 may enable the communication to be transmitted and received over a network 104.

In the preferred embodiment of the present invention, the RPS Protocol is implemented in XLM over Simple Object Access Protocol (hereinafter “SOAP”). SOAP is a lightweight protocol for exchanging information in a decentralized, distributed environment. It is an XML based protocol that includes three parts: an envelope that defines a framework for describing what is in a message and how to process it, a set of encoding rules for expressing instances of application-defined datatypes, and a convention for representing remote procedure calls and responses. SOAP can potentially be used in combination with a variety of other protocols. However, in the preferred embodiment of the present invention, SOAP is used in combination with HTTP and HTTP Extension Framework.

SOAP does not itself define any application semantics such as a programming model or implementation specific semantics. SOAP defines a simple mechanism for expressing application semantics by providing a modular packaging model and encoding mechanisms for encoding data within modules. This allows SOAP to be used in a large variety of systems ranging from messaging systems to RPC.

Data Storage 212 may be implemented in any number of forms. For example, data storage 212 may be a relational database. Data Storage 212 may store data such as documents, folders and web content. The data may be stored as a data structure, such as files. Data Storage 212 may cache retrieved web content and uncache timed out web content.

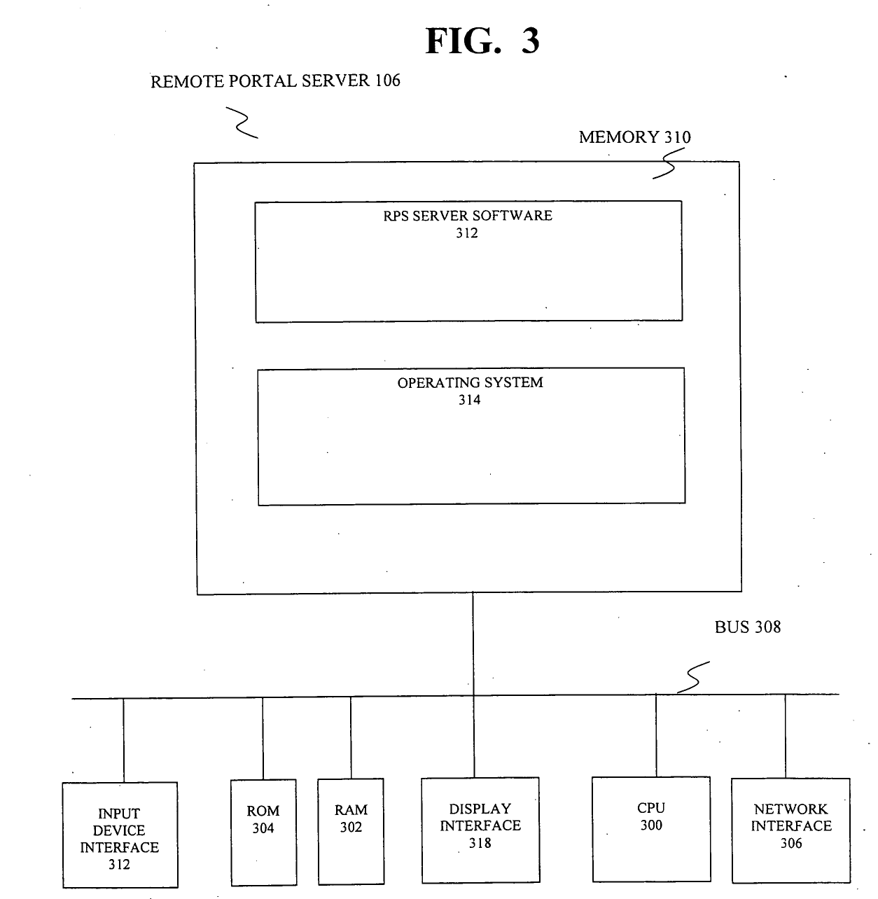

FIG. 3 is a block diagram illustration of Remote Portal server 106. The Remote Portal server 106 may include a central processing unit (CPU) 300, connected by a bus 308 to RAM 302, ROM 304, system memory 310, data storage 312 and network interface 306 which is connected to network 104 for communication with Portal server 102 and communication devices 114. The Remote Portal server 106 may perform the function of enabling and disabling a RPS Service for addition onto a portal provided by Portal server 102. The Remote Portal server 106 can connect to other network resources, for example to acquire information from the Internet or an intranet.

As shown, the various components of the Remote Portal server 106 communicate through a system bus 308 or similar architecture. Accordingly, systems memory 310 is disposed in communication with CPU 300 through bus 308. Typically, CPU 300 is a microprocessor, such as an INTEL PENTIUM® processor, but may also be any processor that executes computer program instructions. Systems memory 310 is the workspace from which all program execution and data processing takes place for Remote Portal server 106. Systems memory 310 includes RPS Server Software 312 and Operating System 314.

Operating System 314 provides overall system functionality. Operating system 314 is the program that, after being initially loaded into the computer, manages all the other programs in server 102. The Operating System 314 finds data and delivers it to RPS Server Software 312. Conversely, when RPS Server Software 312 is ready to output, the operating system 314 transfers the data from RPS Server Software 312 to the appropriate destination. The Operating System 314 is responsible for the central management of all devices. The Operating System 314 calls on one or more drivers for input and output, and the drivers communicate with the corresponding hardware devices.

RPS Server Software 312 provide the functions that are implemented by RPS server 106. RPS Server Software 312 implements object-oriented technology and thus uses objects as building blocks. The objects supported by RPS Server Software 312 include RPS Configuration Descriptor Source, RPS Service Implementation and RPS Module.

RPS Configuration Descriptor Source may be implemented by RPS Server Software 312. RPS Configuration Descriptor Source supplies the RPS Configuration Descriptor for a RPS Service Implementation. In the preferred embodiment of the present invention, A Configuration Descriptor is provided as an XML file. A Configuration Descriptor provides configuration information pertaining to the RPS Service Implementation of a RPS Module. A RPS Module corresponds to a RPS Service hosted by RPS Server 106. RPS Module may be implemented as a PortalBean. The PortalBean is a data structure that may include a descriptor file and view information. The PortalBean may be provided as an XML file. The descriptor file can include description and property information for a RPS Module. The view information may be used to dynamically generate a view. The RPS Module uses the RPS Protocol to communicate with Portal Server Software 216. Network interface 306 may enable communications between RPS Server Software 312 and Portal Server Software 216 to be transmitted and received over a network 104.

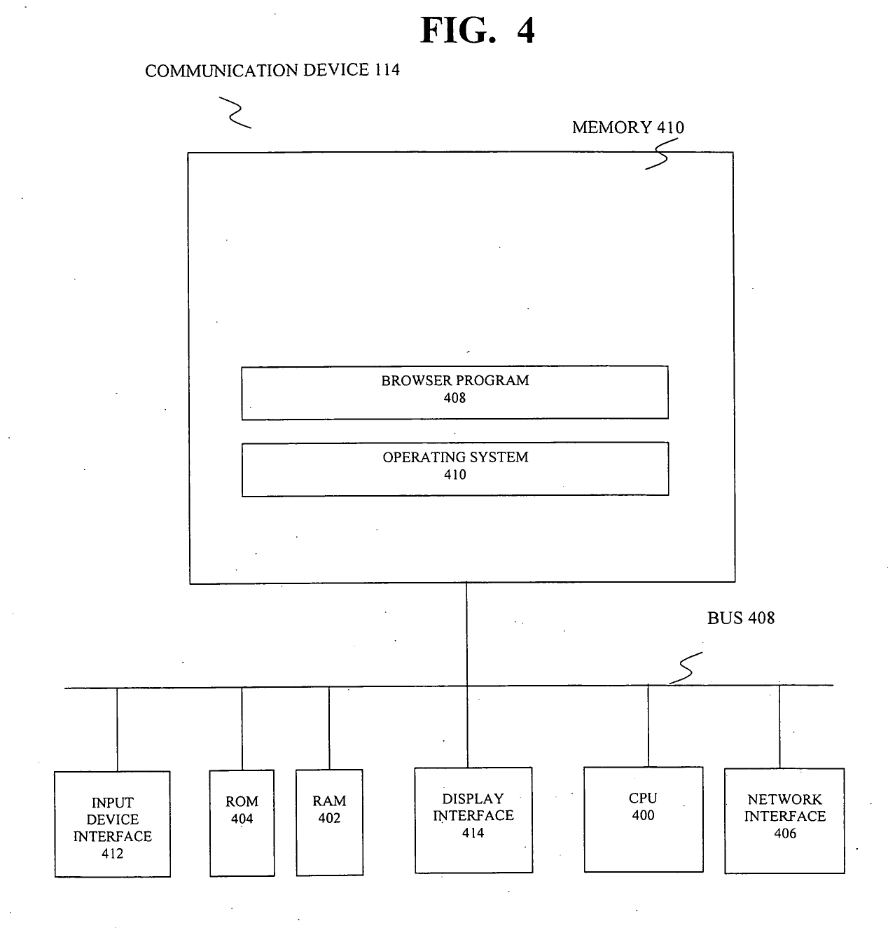

FIG. 4 is a block diagram illustration of Communications devices 114. The Communications devices 114 may include CPU 400, connected by a bus 408 to RAM 402, ROM 404, network interface 406, and system memory 410. Communications device 114 can also include input device interface 412, and display interface 414. Input device interface 412 enables interaction with and execution of instruction by communication device 114 as directed by a user. Display interface 414 can display information generated for output by communication device 114 as provided by Portal server 102. The information may include portals that have a plurality of modules.

As shown, the various components of the communication device 114 communicate through a bus 408 or similar architecture. Accordingly, systems memory 410 is disposed in communication with CPU 400 through bus 408. Systems memory 410 includes Browser Program 416 and Operating System 418.

Operating system 418 provides overall system functionality. Browser Program 416 is computer program instructions executed by CPU 400. The browser program 308 enables the information transmitted from Portal server 102 to be conveyed to a user in a manner that can be understood by a user of communications devices 114. The browser 308 serves as a front end to the World Wide Web on the Internet.

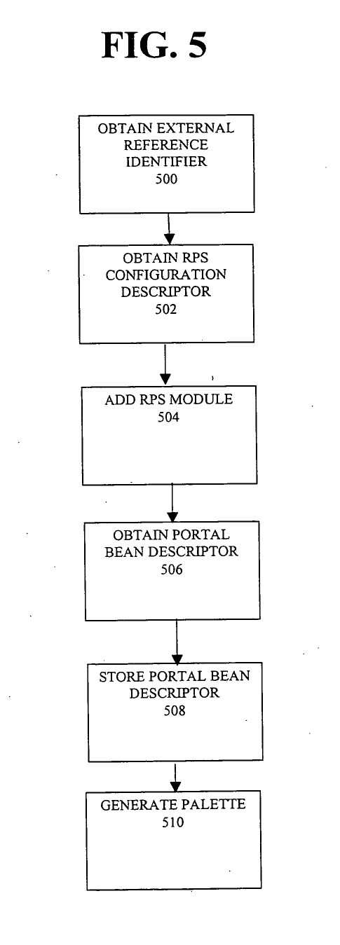

FIG. 5 is a flow diagram which depicts the functions performed by the method of incorporating and providing RPS Modules to a Portal server 102 according to the present invention. As used herein the term remote services is meant to convey applications, content and services hosted on a computer remote from a computer implementing a portal. The remote services are exposed in the portal as RPS Modules without the installation of software specific to the remote applications, content or services.

In Step 500, an external reference identifier is obtained. The external reference identifier may represent a RPS Service Implementation for a RPS Module. In an embodiment of the present invention, the external reference identifier may be listed on a directory. The directory may be hosted by RPS Directory sever 110 or RPS Reference Directory server 112. A RPS Browser Module may provide the directory as well as other object useful for the administration of a portal. A RPS Browser Module may permit instantiation of a RPS Proxy. A RPS Proxy may be instantiated in response to manipulation of an external reference identifier. A RPS Proxy encapsulate and support the use of a RPS Service Implementation. An individual responsible for managing a portal may obtain and manipulate the external reference identifier. For example, the individual may be an administrator or a group of administrators for Portal server 102.

In Step 502, Portal server 102 obtains a RPS Configuration Descriptor for a RPS Service Implementation of a RPS Module on RPS server 106. The RPS Configuration Descriptor may be transmitted over network 104 from RPS server 106. In the preferred embodiment of the present invention, the RPS Configuration Descriptor may be obtained by issuing a Configuration Descriptor Request from Portal server 102 over network 104 to RPS sever 106. A Configuration Descriptor Response provides the configuration information pertaining to the RPS implementation of the RPS Module represented by the external identifier. The Configuration Descriptor Response is transmitted from RPS server 106 over network 104 to Portal server 102. The Configuration response and request are provided using the RPS Protocol.

In Step 504, the RPS Module may be added into Portal server 102. In the preferred embodiment of the present invention, the RPS Module is added by selecting the external reference identifier. In Step 506, a PortalBean Descriptor for the RPS Module is obtained from RPS server 106. The PortalBean Descriptor obtained is for the RPS Module selected by the user Step 504. In the preferred embodiment of the present invention, the PortalBean Descriptor is generated and based on the RPS Configuration Descriptor. In an embodiment of the present invention, the PortalBean Descriptor for the RPS Module is pre-generated. The PortalBean Descriptor is transmitted from RPS server 106 over network 104 to Portal server 102.

In Step 508, the PortalBean Descriptor for the incorporated RPS Module is stored with other PortalBean Descriptors in the memory 310 of RPS Server 106. In Step 510, the set of PortalBean Descriptors that includes the PortalBean Descriptor for the added RPS Module may be used to generated a palette used by the Portal server 102.

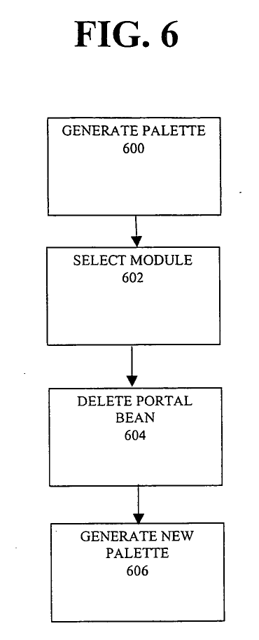

FIG. 6 is a flow diagram which depicts the functions performed by the method of eliminating RPS Modules from a Portal server 102 according to the present invention. The RPS Module corresponds to a RPS Service incorporated onto Portal server 102. The RPS Module may be represented on the palette of Portal server 102.

In Step 600, a palette that includes RPS Modules incorporated onto Portal server 102 is generated. The palette may be display on an interface. An individual responsible for managing the Portal server 102, such as an administrator, may use the interface to perform administration on Portal server 102. In Step 602, a RPS Module is selected. The selected RPS Module corresponds to the RPS Module to be removed from Portal server 102. In Step 604, the PortalBean for the selected RPS Module is deleted. [In Step 606, the set of PortalBean Descriptors, except the PortalBean Descriptor for the removed RPS Module, may be used to generated a palette used by the Portal server 102.

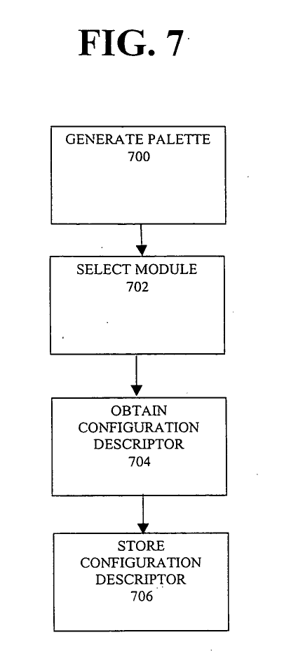

FIG. 7 is a flow diagram which depicts the functions performed by the method of adding RPS Modules into a portal according to the present invention. The RPS Module corresponds to the remote portal service incorporated onto Portal server 102. The RPS Module may be included into a portal of Portal server 102.

In Step 700, a palette that includes RPS Modules incorporated onto Portal server 102 is generated. The palette may be display on an interface. The palette includes all RPS Modules incorporated onto Portal server 102. An individual responsible for managing the Portal server 102, such as an administrator, may use the interface to perform administration on Portal server 102. In Step 702, a RPS Module is selected. In Step 704, Portal server 102 obtains a RPS Configuration Descriptor. The RPS Configuration Descriptor is obtained from the selected RPS Module. In Step 706, the RPS Configuration Descriptor is stored in memory or RPS Server 106. The RPS Configuration Descriptor may be used to connect to the RPS Module.

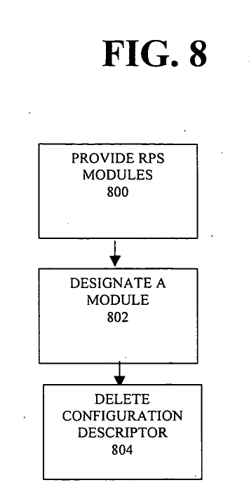

FIG. 8 is a flow diagram which depicts the functions performed by the method of removing RPS Modules from a portal according to the present invention. The RPS Module corresponds to the remote portal service incorporated onto Portal server 102. The RPS Module may be included into a portal of Portal server 102.

In step 800, all RPS modules incorporated onto portal server 102 may be provided. In the preferred embodiment, RPS modules are displayed on a palette. The palette may be displayed on an interface. In step 802, the RPS module to be removed may be designated. In the preferred embodiment, the RPS module to be removed is selected from a palette. The selection may be made by an individual responsible for managing portal server 102. In step 804, descriptor information related to the RPS module is deleted. In the preferred embodiment, the RPS configuration descriptor is deleted from memory of RPS Server 106. The deletion of the RPS configuration descriptor prevents portal server 102 from connecting to a RPS module on RPS server 106.

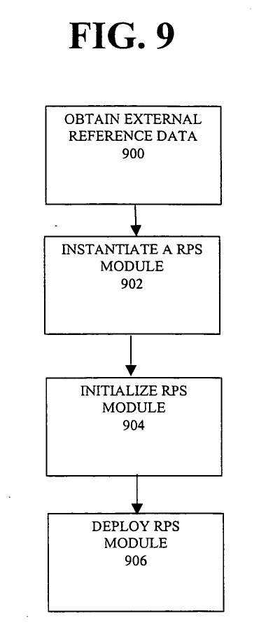

FIG. 9 is a flow diagram which depicts the functions performed by the method of enabling a RPS Modules. The RPS module may be hosted on RPS server 106. The RPS Module may be services of third party content and applications providers.

In step 900, Module information may be provided. In the preferred embodiment, the Module information includes external reference data and type data. The external reference data and type data is related to a RPS Module to be deployed. The deployed RPS module may be incorporated and used by portal server 102. In an embodiment, Module information includes initialization data. The initialization data may be parameters that specifies the configuration specification necessary for proper operation of the module. The data may be provided by an individual responsible for managing RPS Server 106. For example, the individual may be an administrator of RPS server 106. The deployed RPS Module may be provided on a directory. In an embodiment, the RPS Module is provided on a RPS Directory server 110. In another embodiment, the RPS Module is provided on a RPS Reference Directory server 112. The server 110 and 112 may be accessed for the review and incorporation of the RPS module. In step 902, RPS server 106 may instantiate the RPS module. In step 904, RPS server 106 initializes the RPS module. In step 906, the RPS module is deployed for use.

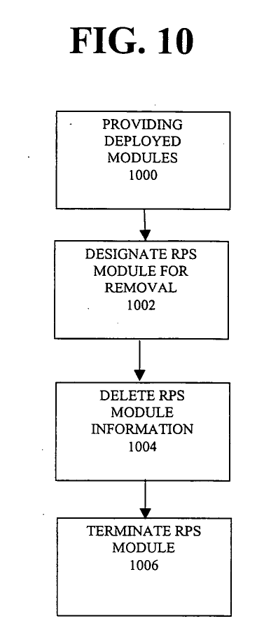

FIG. 10 is a flow diagram which depicts the functions performed by the method of disabling a deployed RPS module. The RPS module may be hosted on RPS server 106. The RPS module may be removed when the service represented by the RPS module is no longer appropriate for distribution and use.

In step 1000, the existing RPS modules currently deployed may be provided. In the preferred embodiment, the existing deployed RPS modules may be listed on a display. In step 1002, a RPS module may be designated for removal. In the preferred embodiment, the designation occurs though the selection of the RPS module is to be removed. The selection may be made by an individual responsible for the management of RPS server 106. For example an administrator of RPS server 106. In an embodiment, several RPS modules are selectable for simultaneous removal. In step 1004, module information is canceled. In the preferred embodiment the module information includes external reference data and type data. In step 1006, the RPS module is terminated. A terminated RPS modules removes the RPS module from use. For example, the RPS module may be eliminated from directory listings.

The present invention is described below with reference to the illustration of the methods, apparatus, computer program product and method of doing business. It will be understood that each block of the flowchart illustrations of FIGS. 5-10, and combinations of blocks in the flowchart illustrations, can be implemented by computer program instructions. These computer program instructions may be loaded onto a general-purpose computer, special purpose computer, or other programmable data processing apparatus to produce a machine. These computer program instructions, which execute on the computer or other programmable data processing apparatus, create means for implementing the functions specified in the flowchart block or blocks. These computer program instructions may be stored in a computer-readable memory to direct a computer or other programmable data processing apparatus to function in a particular manner, producing an article of manufacture including instruction means which implement the function specified in the flowchart block or blocks. The computer program instructions may also be loaded onto a computer or other programmable data processing apparatus to cause a series of operational steps to be performed, producing a computer implemented process, such that the computer or other programmable apparatus provide steps for implementing the functions specified in the flowchart block or blocks. In the preferred embodiment, these computer program instructions are written in an object oriented programming language, such as C, C++ and Java. It is to be appreciated, however, that these computer program instructions may be implemented in any of a wide variety of programming languages.

1-112. (canceled)

113. A method for providing a remote service in a portal, the method comprising:
obtaining an identifier corresponding to a remote service, wherein the remote service is hosted by a remote system and the remote system is remote from a portal system;
obtaining configuration information corresponding to the remote service, wherein the configuration information is obtained using the identifier; and
incorporating the remote service into a remote portal service module in a portal using the configuration information such that the remote service is exposed in the remote portal service module, wherein the portal is provided by the portal system.

114. The method according to claim 113, wherein obtaining an identifier is performed based on a portal system protocol.

115. The method according to claim 114, wherein obtaining the identifier is performed based on XML over Simple Object Access Protocol (SOAP).

116. The method according to claim 113, wherein the identifier is obtained from a directory hosted by a remote server.

117. The method according to claim 116, wherein the identifier comprises an RPS browser module.

118. The method according to claim 116, wherein the identifier is obtained from a directory provided by a remote module.

119. The method according to claim 118, wherein obtaining the identifier further comprises obtaining an object for administration of a portal.

120. The method according to claim 113, further comprising obtaining a descriptor file and view information for the remote service.

121. The method according to claim 113, wherein the configuration information comprises remote configuration data, and wherein the remote configuration data is obtained by issuing a request from the portal system to the remote system.

122. The method according to claim 121, further comprising generating a descriptor file from the remote configuration data.

123. A portal system for providing a portal, the system comprising:
a first server operable to obtain data from a remote system, wherein the data pertains to a remote service on the remote system, and wherein the remote system is remote from the portal system; and
a second server for providing a portal, wherein the second server is coupled to the first server, and wherein the portal includes a set of modules, wherein at least one of the set of modules is a remote portal service (RPS) module, and wherein the second server is operable to receive the data and expose the data in the RPS module.

124. The system according to claim 123, wherein said data is transferred based on a portal system protocol.

125. The system according to claim 124, wherein said portal system protocol is implemented in XML over Simple Object Access Protocol (SOAP).

126. The system according to claim 123, further comprising a third server, wherein the third server is coupled to the first and second servers, and wherein the third server is operable to locate and list remote portal services.

127. The system according to claim 126, further comprising a fourth server, wherein the fourth server is coupled to the first, second, and third servers, and wherein the fourth server is operable to locate and list remote portal services and indicate invalid information.

128. The system according to claim 123, wherein the second server is operable to perform the functions of incorporating, eliminating, adding, or removing a remote portal service.

129. The system according to claim 128, wherein functions performed by the second server are executed by portal server software using a library of object-oriented classes.

130. The system according to claim 129, wherein the portal server software is adapted to implement a remote portal browser module, proxy, and service implementation.

131. The system according to claim 129, wherein the portal server software is operable to provide dynamic construction and dynamic maintenance of an initial set of portals, wherein the initial set of portals includes a plurality of modules.

132. The system according to claim 130, wherein at least one of said plurality of modules is implemented on the first server.

133. A method for providing a remote service in a portal, the method comprising:
providing a portal with a portal system, wherein the portal includes a set of modules, and wherein at least one of the set of modules is a remote portal service (RPS) module;
obtaining data corresponding to a remote service on a remote system, wherein the remote system is remote from the portal system; and
exposing the data in the RPS module.

134. The method according to claim 133, wherein the data is obtained based on a portal system protocol.

135. The method according to claim 133, wherein the data is obtained based on an XML over Simple Object Access Protocol (SOAP).

136. The method according to claim 133, wherein the data comprises configuration information from the remote system

137. The method according to claim 136, wherein the configuration information obtained from the remote system comprises an XML file.

138. The method according to claim 136, wherein the configuration information obtained from the remote system comprises information pertaining to an RPS module service implementation.

139. The method according to claim 138, wherein the information pertaining to an RPS module service implementation comprises a data structure.

140. The method according to claim 139, wherein the data structure comprises a descriptor file and view information.

141. The method according to claim 139, wherein the data structure comprises an XML file.

142. The method according to claim 140, wherein the descriptor file comprises description and property information for the RPS module.

143. The method according to claim 140 wherein exposing the data in the RPS module comprises dynamically generating a view using the view information.
